(19) United States
(12) Patent Application Publication
(10) Pub. No.: US 2008/0147414 A1
(43) Pub. Date: Jun. 19, 2008

(54) METHOD AND APPARATUS TO DETERMINE ENCODING MODE OF AUDIO SIGNAL AND METHOD AND APPARATUS TO ENCODE AND/OR DECODE AUDIO SIGNAL USING THE ENCODING MODE DETERMINATION METHOD AND APPARATUS

(75) Inventors: Chang-yong Son, Gunpo-si (KR); Eun-mi Oh, Seongnam-si (KR); Ki-hyun Choo, Seoul (KR); Jung-hoe Kim, Seoul (KR); Ho-sang Sung, Yongin-si (KR); Kang-eun Lee, Gangneung-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/939,074

(22) Filed: Nov. 13, 2007

(30) Foreign Application Priority Data
Dec. 14, 2006 (KR) 2006-127844

(51) Int. Cl. G10L 19/06

(52) U.S. Cl. 704/500

(57) ABSTRACT

A method and apparatus to determine an encoding mode of an audio signal, and a method and apparatus to encode an audio signal according to the encoding mode. In the encoding mode determination method, a mode determination threshold for the current frame that is subject to encoding mode determination is adaptively adjusted according to a long-term feature of the audio signal for a frame (the current frame) that is subject to encoding mode determination, thereby improving the hit rate of encoding mode determination and signal classification, suppressing frequent oscillation of an encoding mode in frame units, improving noise tolerance, and improving smoothness of a reconstructed audio signal.

### CROSS-REFERENCE TO RELATED APPLICATIONS

This application claims the benefit of Korean Patent Application No. 10-2006-0127844, filed on Dec. 14, 2006, in the Korean Intellectual Property Office, the disclosure of which is incorporated herein in its entirety by reference.

### BACKGROUND OF THE INVENTION

1. Field of the Invention

The present general inventive concept relates to a method and apparatus to determine an encoding mode of an audio signal and a method and apparatus to encode and/or decode an audio signal using the encoding mode determination method and apparatus, and more particularly, to an encoding mode determination method and apparatus which can be used in an encoding apparatus to determine an encoding mode of an audio signal according to a domain and a coding method that are suitable for encoding the audio signal.

2. Description of the Related Art

Audio signals can be classified as various types, such as speech signals, music signals, or mixtures of speech signals and music signals, according to their characteristics, and different coding methods or compression methods are applied to the various types of the audio signal.

The compression methods for audio signals can be divided into an audio codec and a speech codec. The audio codec, such as Advanced Audio Coding Plus (aacPlus), is intended to compress music signals. The audio codec compresses a music signal in a frequency domain using a psychoacoustic model. However, when a speech signal is compressed using the audio codec, sound quality degrades, and the sound quality degradation becomes more serious when the speech signal includes an attack signal. The speech codec, such as Adaptive Multi Rate-WideBand (AMR-WB), is intended to compress speech signals. The speech codec compresses an audio signal in a time domain using an utterance model. However, when an audio signal is compressed using the speech codec, sound quality degrades.

In order to efficiently perform speech/music compression at the same time based on the above-described characteristics, AMR−WB+(3GPP TS 26.290) has been suggested. AMR−WB+is a speech compression method using algebraic code excited linear prediction (ACELP) for speech compression and transform coded excitation (TCX) for audio compression.

AMR−WB+determines whether to apply ACELP or TCX for each frame on a time axis. Although AMR−WB+works efficiently for a compression object that approximates a speech signal, it may cause degradation in sound quality or compression rate for a compression object that approximates a music signal. Thus, when different compression methods are applied according to the characteristics or modes of an audio signal, a method for determining an encoding mode has a great influence on the performance of encoding or compression with respect to the audio signal.

U.S. Pat. No. 6,134,518 discloses a conventional method for coding a digital audio signal using a CELP coder and a transform coder. Referring to FIG. 1, a classifier 20 measures autocorrelation of an input audio signal 10 to select one of a CELP coder 30 and a transform coder 40 based on the measurement of the autocorrelation. The input audio signal 10 is coded by one of the CELP coder 30 and the transform coder 40 selected by switching of a switch 50. The conventional method selects the best encoding mode by the classifier 20 that calculates a probability that the current mode is a speech signal or a music signal using autocorrelation in the time domain.

However, because of weak noise tolerance, the conventional method has a low hit rate of mode determination and signal classification under noisy conditions. That is, the mode determination and signal classification are inaccurately performed. Moreover, frequent mode oscillation in frame units cannot provide a smooth reconstructed audio signal.

### SUMMARY OF THE INVENTION

The present general inventive concept provides a method and apparatus to determine an encoding mode to encode an audio signal.

The present general inventive concept provides a method and apparatus to improve a hit rate of mode determination and signal classification under noisy conditions when encoding an audio signal.

The present general inventive concept provides a method and apparatus to adaptably adjust a mode determining threshold to determine an encoding mode according to the adjusted mode determining threshold.

The present general inventive concept provides a method and apparatus to encode and/or decode an audio signal according to an adaptably determined encoding mode.

The present general inventive concept provides a computer readable medium to execute a method of determining an encoding mode to encode an audio signal

Additional aspects and utilities of the present general inventive concept will be set forth in part in the description which follows and, in part, will be obvious from the description, or may be learned by practice of the general inventive concept.

The foregoing and/or other aspects of the present general inventive concept may be achieved by providing an apparatus to determine an encoding mode to encode an audio signal, the apparatus including a determination unit to determine an encoding mode of a first frame of an audio signal according to a short-term feature of the first frame and a long-term feature between the first frame and a second frame so that the first frame of the audio signal is encoded according to the encoding mode.

The apparatus may further include a time-domain coding unit to encode the audio signal according to the encoding mode and a time-domain, and a frequency-domain coding unit to encode the audio signal according to the encoding mode and a frequency-domain.

The apparatus may further include a speech coding unit to encode the audio signal as a speech signal according to the encoding mode, and a music coding unit to encode the audio signal as a music signal according to the encoding mode.

The apparatus may further include a speech coding unit to receive the audio signal and the encoding mode from the determining unit to encode the audio signal when the encoding mode is a speech signal encoding mode, and a music coding unit to receive the audio signal and the encoding mode from the determining unit to encode the audio signal when the encoding mode is a music signal encoding mode.

The apparatus may further include a coding unit to encode the audio signal according to the encoding mode, and a bitstream generation unit to generate a bitstream according to the encoded audio signal and information on the encoding mode.

The determining unit may include a short term feature generation unit to generate the short-term feature from the first frame of the audio signal, and a long-term feature generation unit to generate the long-term feature from the first frame and the second frame.

The determining unit may further include a mode determination threshold adjustment unit to adjust a mode determination threshold according to the short term feature and the long-term feature, and an encoding determination unit to determine the encoding mode according to the adjusted mode determination threshold and the short-term feature.

The mode determination threshold adjustment unit may adjust the mode determination threshold according to the short term feature, the long-term feature, and a second encoding mode of the second frame.

The encoding determination unit may determine the encoding mode according to the adjusted mode determination threshold, the short-term feature, and a second encoding mode of the second frame.

The long-term feature generation unit may include a first long-term feature generation unit to generate a first long-term feature according to the short-term feature of the first frame and a second short-term feature of the second feature, and a second long-term feature generation unit to generate a second long-term feature as the long-term feature according to the first long-term feature and a variation feature of at least one of the first frame and the second frame.

The determination unit may further include a mode determination threshold adjustment unit to adjust a mode determination threshold according to the short term feature and the second long-term feature, and an encoding determination unit to determine the encoding mode according to the adjusted mode determination threshold and the short-term feature.

The determination unit may determine the encoding mode of the first frame of the audio signal according to the short-term feature of the first frame, the long-term feature between the first frame and the second frame, and a second encoding mode of the second frame.

The determination unit may include an LP-LTP gain generation unit to generate an LP-LTP gain as the short-term feature of the first frame, and a long-term feature generation unit to generate the long-term feature according to the LP-LTP gain of the first frame and a second LP-LTP gain of the second frame.

The determination unit may include a spectrum tilt generation unit to generate a spectrum tilt as the short-term feature of the first frame, and a long-term feature generation unit to generate the long-term feature according to the spectrum tilt of the first frame and a second spectrum tilt of the second frame.

The determination unit may include a zero crossing rate generation unit to generate a zero crossing rate as the short-term feature of the first frame, and a long-term feature generation unit to generate the long-term feature according to the zero crossing rate of the first frame and a second zero crossing rate of the second frame.

The determination unit may include a short-term feature generation unit having one or a combination of an LP-LTP gain generation unit to generate an LP-LTP gain as the short-term feature of the first frame, a spectrum tilt generation unit to generate a spectrum tilt as the short-term feature of the first frame, and a zero crossing rate generation unit to generate a zero crossing rate as the short-term feature of the first frame, and a long-term feature generation unit to generate the long-term feature according to the short-term feature of the first frame and a second short-term feature of the second frame.

The determination unit may include a memory to store the short-term and long-term features of the first and second frames.

The first frame may be a current frame; the second frame may include a plurality of previous frames, and the long-term feature may be determined according to the short-term feature of the first frame and second short-term features of the plurality of the previous frames.

The first frame may be a current frame, the second frame may be a previous frame, and the long-term feature may be determined according to a variation feature between the current frame and the previous frame.

The first frame may be a current frame, the second frame may include a previous frame, and the long-term feature may be determined according to a variation feature of a second encoding mode of the previous frame.

The foregoing and/or other aspects of the present general inventive concept may also be achieved by providing an apparatus to encode an audio signal, the apparatus including a determination unit to determine an encoding mode of a first frame of an audio signal according to a short-term feature of the first frame, a long-term feature between the first frame and a second frame, and a second encoding mode of the second frame, so that the first frame of the audio signal is encoded according to the encoding mode.

The foregoing and/or other aspects of the present general inventive concept may also be achieved by providing an apparatus to encode an audio signal, the apparatus including a determining unit to determine one of a speech mode and a music mode as an encoding mode to encode an audio signal according to a unique characteristic of a frame the audio signal and a relative characteristic of adjacent frames of the audio signal.

The foregoing and/or other aspects of the present general inventive concept may also be achieved by providing an apparatus to decode a signal of a bitstream, the apparatus including a determining unit to determine an encoding mode from a bitstream having en encoded signal and information on the encoding mode of the encoded signal, so that the encoded signal of the bitstream is decoded according to the determined encoding mode.

The foregoing and/or other aspects of the present general inventive concept may also be achieved by providing an apparatus to encode and/or decode an audio signal, the apparatus including a first determining unit to determine an encoding mode of a first frame of an audio signal according to a short-term feature of the first frame and a long-term feature between the frame and a second frame so that the first frame of the audio signal is encoded according to the encoding mode; and a second determining unit to determine the encoding mode from a bitstream having the encoded signal and information on the encoding mode, so that the encoded signal of the bitstream is decoded according to the determined encoding mode.

The foregoing and/or other aspects of the present general inventive concept may also be achieved by providing a method of an apparatus to determine an encoding mode to encode an audio signal, the method including determining an encoding mode of a first frame of an audio signal according to a short-term feature of the first frame and a long-term feature between the first frame and a second frame so that the first frame of the audio signal is encoded according to the encoding mode.

The foregoing and/or other aspects of the present general inventive concept may also be achieved by providing a method of an apparatus to decode a signal of a bitstream, the method including determining an encoding mode from a bitstream having en encoded signal and information on the encoding mode of the encoded signal, so that the encoded signal of the bitstream is decoded according to the determined encoding mode.

The foregoing and/or other aspects of the present general inventive concept may also be achieved by providing a method of an apparatus to encode and/or decode an audio signal, the method including determining an encoding mode of a first frame of an audio signal according to a short-term feature of the first frame and a long-term feature between the frame and a second frame so that the first frame of the audio signal is encoded according to the encoding mode, and determining the encoding mode from a bitstream having the encoded signal and information on the encoding mode, so that the encoded signal of the bitstream is decoded according to the determined encoding mode.

The foregoing and/or other aspects of the present general inventive concept may also be achieved by providing a computer-readable medium containing computer readable codes as a program to execute a method of an apparatus to determine an encoding mode to encode an audio signal, the method including determining an encoding mode of a first frame of an audio signal according to a short-term feature of the first frame and a long-term feature between the first frame and a second frame so that the first frame of the audio signal is encoded according to the encoding mode.

The foregoing and/or other aspects of the present general inventive concept may also be achieved by providing a computer-readable medium containing computer readable codes as a program to execute a method of an apparatus to decode a signal of a bitstream, the method including determining an encoding mode from a bitstream having en encoded signal and information on the encoding mode of the encoded signal, so that the encoded signal of the bitstream is decoded according to the determined encoding mode.

The foregoing and/or other aspects of the present general inventive concept may also be achieved by providing a computer-readable medium containing computer readable codes as a program to execute a method of an apparatus to encode and/or decode an audio signal, the method including determining an encoding mode of a first frame of an audio signal according to a short-term feature of the first frame and a long-term feature between the frame and a second frame so that the first frame of the audio signal is encoded according to the encoding mode, and determining the encoding mode from a bitstream having the encoded signal and information on the encoding mode, so that the encoded signal of the bitstream is decoded according to the determined encoding mode.

The foregoing and/or other aspects of the present general inventive concept may also be achieved by providing an apparatus to determine an encoding mode to encode an audio signal, the apparatus including a first generation unit to generate a short-term feature of a first frame, a second generation unit to adjust the short-term feature to a long-term feature according to a second short-feature of a second frame, an encoding mode determination unit to determine an encoding mode of the first frame of an audio signal according to the short-term feature and the long-term feature, and an encoding unit to encode the first frame of the audio signal according to the encoding unit.

The foregoing and/or other aspects of the present general inventive concept may also be achieved by providing an apparatus to determine an encoding mode to encode an audio signal, the apparatus including a first generation unit to generate a short-term feature of a first frame, a second generation unit to adjust the short-term feature according to a variation feature of the first frame with respect to a second frame, and to generate a long-term feature, an encoding mode determination unit to determine an encoding mode of the first frame of an audio signal according to the short-term feature and the long-term feature, and an encoding unit to encode the first frame of the audio signal according to the encoding unit.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram of a conventional audio signal encoder;

FIG. 2A is a block diagram of an encoding apparatus to encode an audio signal according to an exemplary embodiment of the present general inventive concept;

FIG. 2B is a block diagram of an encoding apparatus to encode an audio signal according to another exemplary embodiment of the present general inventive concept;

FIG. 3 is a block diagram of an encoding mode determination apparatus to determine en encoding mode to encode an audio signal according to an exemplary embodiment of the present general inventive concept;

FIG. 4 is a detailed block diagram of a short-term feature generation unit and a long-term feature generation unit illustrated in FIG. 3;

FIG. 5 is a detailed block diagram of a linear prediction-long-term prediction (LP-LTP) gain generation unit illustrated in FIG. 4;

FIG. 6A is a screen shot illustrating a variation feature SNR_Var of an LP-LTP gain according to a music signal and a speech signal;

FIG. 6B is a reference diagram illustrating a distribution feature of a frequency percent according to the variation feature SNR_VAR of FIG. 6A;

FIG. 6C is a reference diagram illustrating the distribution feature of cumulative frequency percent according to the variation feature SNR_VAR of FIG. 6A;

FIG. 6D is a reference diagram illustrating a long-term feature SNR_SP according to an LP-LTP gain of FIG. 6A;

FIG. 7A is a screen shot illustrating a variation feature TILT_VAR of a spectrum tilt according to a music signal and a speech signal;

FIG. 7B is a reference diagram illustrating a long-term feature TILT_SP of the spectrum tilt of FIG. 7A;

FIG. 8A is reference diagram illustrating a variation feature ZC_Var of a zero crossing rate according to a music signal and a speech signal;

FIG. 8B is a screen shot illustrating a long-term feature ZC_SP with respect to the zero crossing rate of FIG. 8A;

FIG. 9A is a reference diagram illustrating a long-term feature SPP according to a music signal and a speech signal;

FIG. 9B is a reference diagram illustrating a cumulative long-term feature SPP according to the long-term feature SPP of FIG. 9A;

FIG. 10 is a flowchart illustrating an encoding mode determination method of determining en encoding mode to encode an audio signal according to an exemplary embodiment of the present general inventive concept; and

FIG. 11 is a block diagram of a decoding apparatus to decode an audio signal according to an exemplary embodiment of the present general inventive concept.

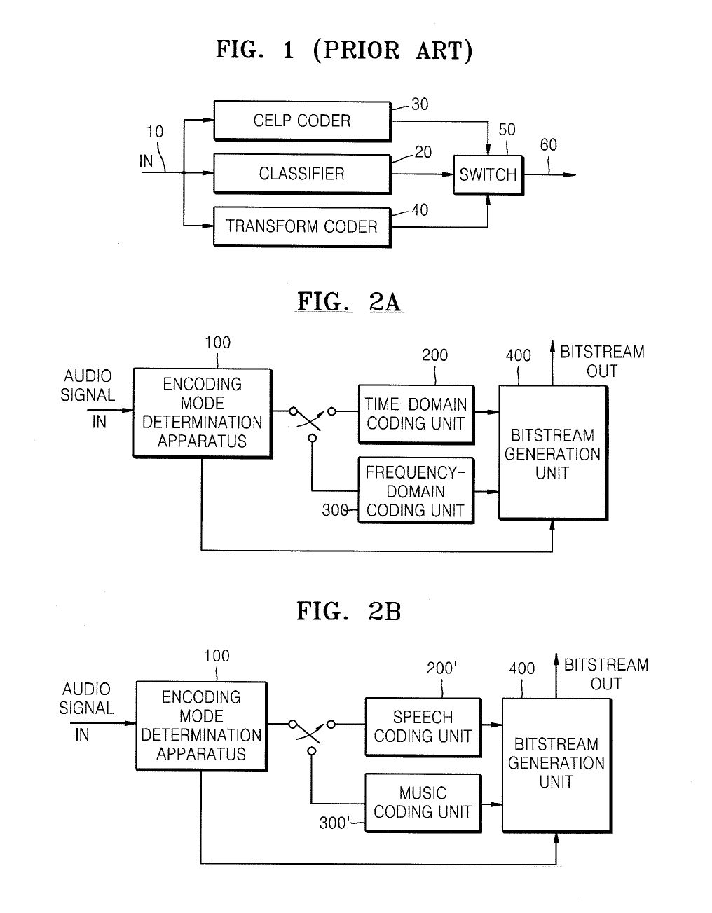

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 2A is a block diagram of an encoding apparatus to encode an audio signal according to an exemplary embodiment of the present general inventive concept. Referring to FIG. 2A, the encoding apparatus includes an encoding mode determination apparatus 100, a time-domain coding unit 200, a frequency-domain coding unit 300, and a bitstream muxing (multiplexing) unit 400.

The encoding mode determination apparatus 100 may include a divider (not shown) to divide an input audio signal into frames based on an input time of the audio signal and determines whether each of the frames is subject to frequency-domain coding or time-domain coding. The encoding mode determination apparatus 100 transmits mode information, indicating whether a current frame is subject to the frequency-domain coding or the time-domain coding, to the bitstream muxing unit 400 as additional information.

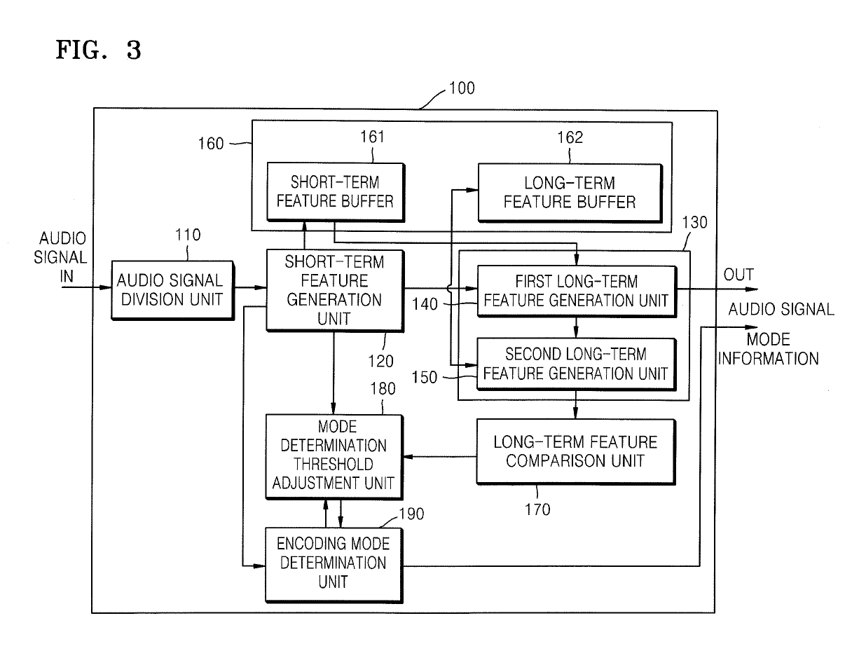

The encoding mode determination apparatus 100 may further include a time/frequency conversion unit (not shown) that converts an audio signal of a time domain into an audio signal of a frequency domain. In this case, the encoding mode determination apparatus 100 can determine an encoding mode for each of the frames of the audio signal in the frequency domain. The encoding mode determination apparatus 100 transmits the divided audio signal to either the time-domain coding unit 200 or the frequency-domain coding unit 300 according to the determined encoding mode. The detailed structure of the encoding mode determination apparatus 100 is illustrated in FIG. 3 and will be described later.

The time-domain coding unit 200 encodes the audio signal corresponding to the current frame to be encoded in an encoding mode determined by the encoding mode determination apparatus 100 in the time domain and transmits the encoded audio signal to the bitstream muxing unit 400. In the present embodiment, the time-domain encoding may be a speech compression algorithm that performs compression in the time domain, such as code excited linear prediction (CELP).

The frequency-domain coding unit 300 encodes the audio signal corresponding to the current frame in the encoding mode determined by the encoding mode determination apparatus 100 in the frequency domain and transmits the encoded audio signal to the bitstream muxing unit 400. Since the input audio signal is a time-domain signal, a time/frequency conversion unit (not shown) may be further included to convert the input audio signal of the time domain to an audio signal of the frequency domain. In the present embodiment, the frequency-domain encoding is an audio compression algorithm that performs compression in the frequency domain, such as transform coded excitation (TCX), advanced audio codec (AAC), and the like.

The bitstream muxing unit 400 receives the encoded audio signal from the time-domain coding unit 200 or the frequency domain coding unit 300 and the mode information from the encoding mode determination apparatus 100, and generates a bitstream using the received signal and mode information. In particular, the mode information can also be used to determine a decoding mode when signals corresponding to the bit stream are decoded to reconstruct the audio signal.

FIG. 2B is a block diagram of an encoding apparatus to encode an audio signal according to another exemplary embodiment of the present general inventive concept. Referring to FIG. 2B, the encoding apparatus includes the encoding mode determination apparatus 100, a speech coding unit 200′, a music coding unit 300′, and the bitstream muxing (multiplexing) unit 400.

The encoding mode determination apparatus 100 may include a divider to divide an input audio signal into frames based on an input time of the audio signal and determines whether each frame is subject to speech coding or music coding. The encoding mode determination apparatus 100 also transmits mode information, indicating whether the current frame is subject to speech coding and music coding, to the bitstream muxing unit 400 as additional information. The speech coding unit 200′, the music coding unit 300′, and the bitstream muxing unit 400 correspond to the time-domain coding unit 200, the frequency-domain coding unit 300, and the bitstream muxing unit 400 illustrated in FIG. 2A, respectively, and thus detail descriptions thereof will be omitted.

FIG. 3 is a detailed block diagram of the encoding mode determination apparatus 100 of FIGS. 2A and 2B according to an exemplary embodiment of the present general inventive concept. Referring to FIG. 3, the encoding mode determination apparatus 100 includes an audio signal division unit 110, a short-term feature generation unit 120, a long-term feature generation unit 130, a buffer 160 including a short-term feature buffer 161 and a long-term feature buffer 162, a long-term feature comparison unit 170, a mode determination threshold adjustment unit 180, and an encoding mode determination unit 190. The buffer may be a memory, such as a RAM or flash memory.

The audio signal division unit 110 divides an input audio signal into frames in the time domain and transmits the divided audio signal to the short-term feature generation unit 120.

The short-term feature generation unit 120 performs short-term analysis with respect to the divided audio signal to generate a short-term feature. In the present embodiment, the short-term feature is a unique feature of each frame to be used to determine whether a current frame is in a music mode or a speech mode and which one of time-domain coding and frequency-domain coding is efficient for the current frame.

The short-term feature may include a linear prediction-long-term prediction (LP-LTP) gain, a spectrum tilt, a zero crossing rate, a spectrum autocorrelation, and the like.

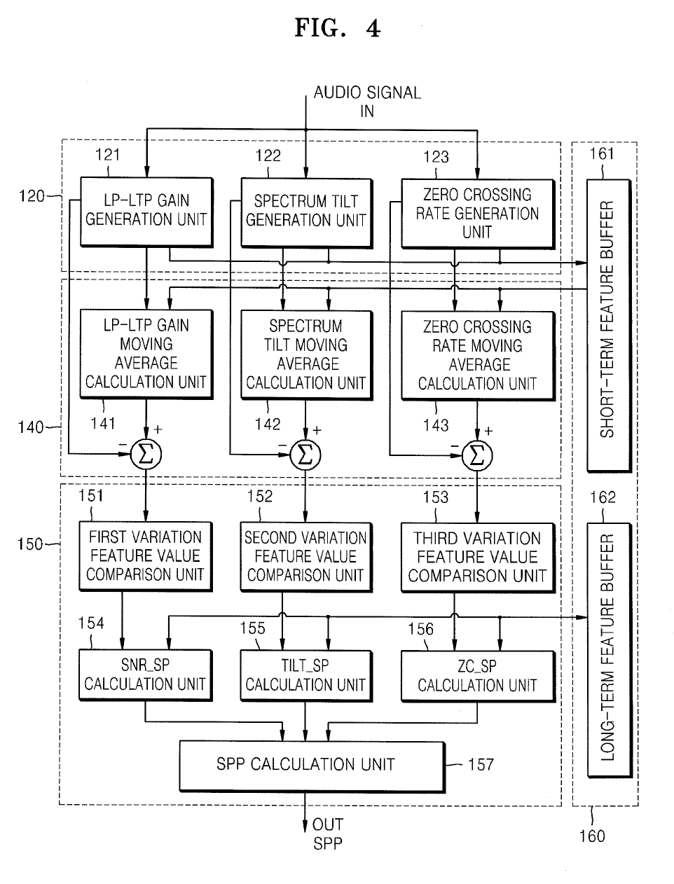

The short-term feature generation unit 120 may independently generate and output one short-term feature or a plurality of short-term features or may output a sum of a plurality of weighted short-term features as a representative short-term feature. The detailed structure of the short-term feature generation unit 120 is illustrated in FIG. 4 and will be described later.

The long-term feature generation unit 130 generates a long-term feature using the short-term feature generated by the short-term feature generation unit 120 and features that are stored in the short-term feature buffer 161 and the long-term feature buffer 162. The long-term feature generation unit 130 includes a first long-term feature generation unit 140 and a second long-term feature generation unit 150.

The first long-term feature generation unit 140 obtains information about the stored short-term features of a plurality of previous frames, for example, five (5) consecutive previous frames, preceding the current frame from the short-term feature buffer 161 to calculate an average value and calculates a difference between the short-term feature of the current frame and the calculated average value to generate a variation feature.

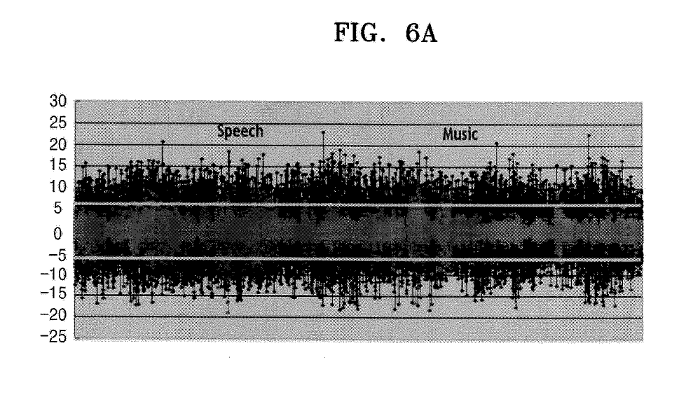

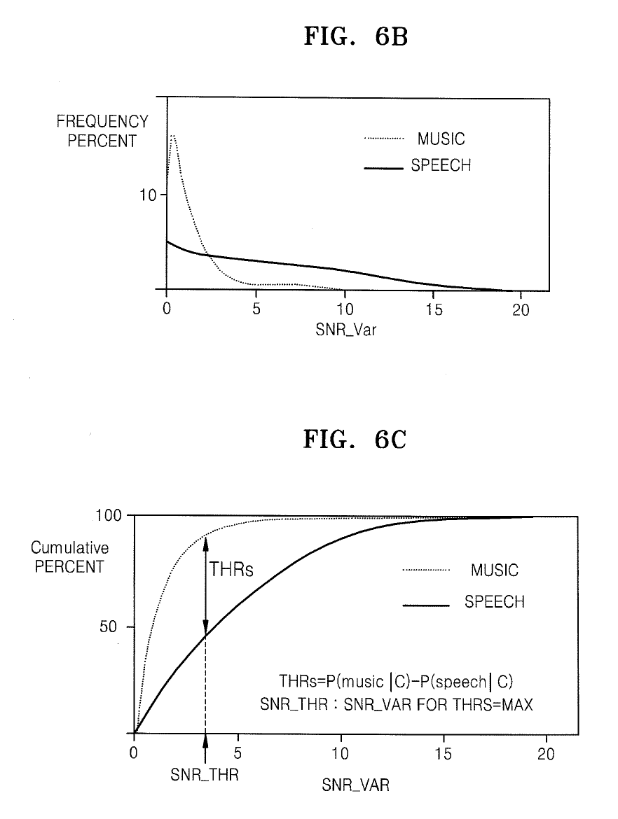

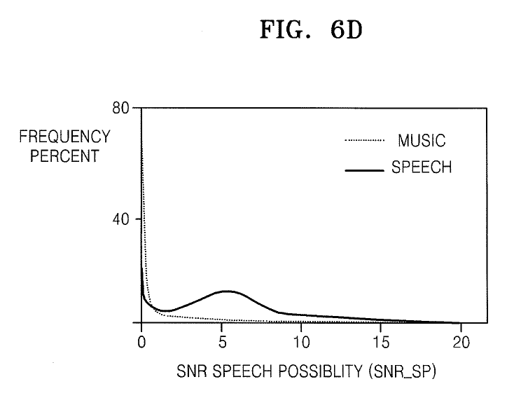

When the short-term feature is an LP-LTP gain, the average value is an average of LP-LTP gains of the previous frames preceding the current frame and the variation feature is information describing how much the LP-LTP gain of the current frame deviates from the average value corresponding to a predetermined term or period. As illustrated in FIG. 6B, a variation feature Signal to Noise Ratio Variation (SNR_VAR) is distributed over different areas when the audio signal is a speech signal or in a speech mode, while the variation feature SNR_VAR is concentrated over a small area when the audio signal is a music signal or in a music mode. Detail descriptions of FIG. 6B will be described later.

The second long-term feature generation unit 150 generates a long-term feature having a moving average that considers a per-frame change in the variation feature generated by the first long-term feature generation unit 140 under a predetermined constraint. Here, the predetermined constraint represents a condition and a method to apply a weight to the variation feature of a previous frame preceding the current frame.

In particular, the second long-term feature generation unit 150 distinguishes between a case where the variation feature of the current frame is greater than a predetermined threshold and a case where the variation feature of the current frame is less than the predetermined threshold and applies different weights to the variation feature of the previous frame and the variation feature of the current frame, thereby generating the long-term feature. Here, the predetermined threshold is a preset value for distinguishing between a speech mode and a music mode. The generation of the long-term feature will be described in more detail later.

As mentioned above, the buffer 160 includes the short-term feature buffer 161 and the long-term feature buffer 162. The short-term feature buffer 161 stores one or more short-term features generated by the short-term feature generation unit 120 for at least a predetermined period of time and the long-term feature buffer 162 stores one or more long-term features generated by the first long-term feature generation unit 140 and the second long-term feature generation unit 150 for at least a predetermined period of time.

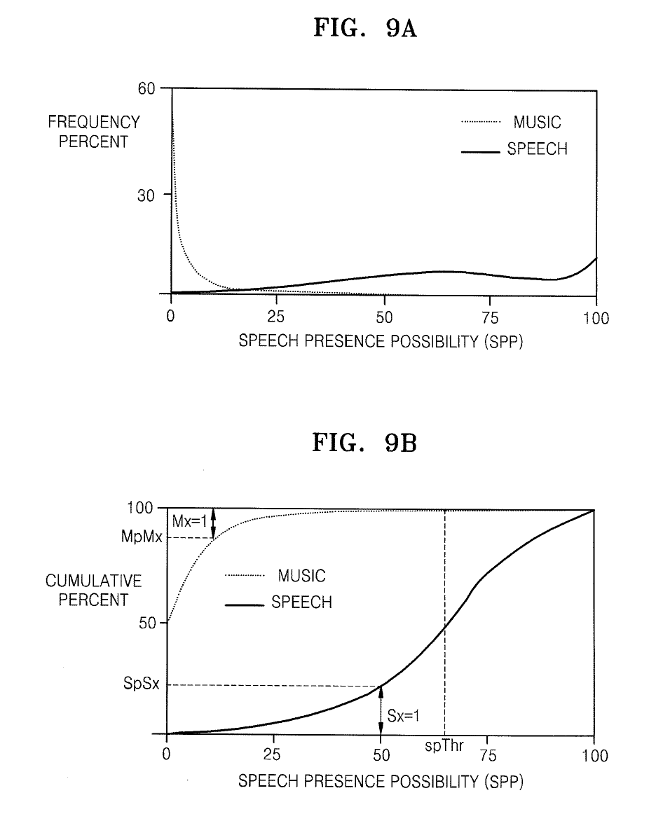

The long-term feature comparison unit 170 compares the long-term feature generated by the second long-term feature generation unit 150 with a predetermined threshold to generate a comparison result. Here, the predetermined threshold is a long-term feature for the case where there is a high possibility that the current mode is a speech mode and is previously determined by statistical analysis with respect to speech signals and music signals. When a threshold SpThr for a long-term feature is set as illustrated in FIG. 9B and the long-term feature generated by the second long-term feature generation unit 150 is greater than the threshold SpThr, the possibility that the current frame is a music signal is less than 1%. In other words, when the long-term feature is greater than the threshold, a speech coding mode can be determined as the encoding mode for the current frame.

When the long-term feature is less than the threshold, the encoding mode for the current frame can be determined by a process of adjusting a mode determination threshold and comparing the short-term feature with the adjusted mode determination threshold. The mode determination threshold can be adjusted based on a hit rate of mode determination, and as illustrated in FIG. 9B, the hit rate of the mode determination is lowered by setting the mode determination threshold low.

The mode determination threshold adjustment unit 180 adaptively adjusts the mode determination threshold that is referred to for determining the encoding mode for the current frame when the long-term feature generated by the second long-term feature generation unit 150 is less than the threshold, i.e., when it is difficult to determine the encoding mode for the current frame only with the long-term feature.

The mode determination threshold adjustment unit 180 receives mode information of a previous frame from the encoding mode determination unit 190 and adjusts the mode determination threshold adaptively according to a determination of whether the previous frame is in the speech mode or the music mode, the short term feature received from the short-term feature generation unit 120, and the comparison result received from the long-term feature comparison unit 170s. The mode determination threshold is used to determine of which one of the speech mode and the music mode has a property of the short-term feature of the current frame. In the present embodiment, the mode determination threshold is adjusted according to the encoding mode of the previous frame preceding the current frame. The adjustment of the mode determination threshold will be described in detail later.

The encoding mode determination unit 190 compares a short-term feature STF_THR of the current frame received from the short-term feature generation unit 120 with a mode determination threshold STF_THR adjusted by the mode determination threshold adjustment unit 180 in order to determine whether the encoding mode for the current frame is the speech mode or the music mode.

FIG. 4 is a detailed block diagram of the short-term feature generation unit 120 and the long-term feature generation unit 130 illustrated in FIG. 3. The short-term feature generation unit 120 includes an LP-LTP gain generation unit 121, a spectrum tilt generation unit 122, and a zero crossing rate (ZCR) generation unit 123. The long-term feature generation unit 130 includes an LP-LTP gain moving average calculation unit 141, a spectrum tilt moving average calculation unit 142, a zero crossing rate moving average calculation unit 143, a first variation feature comparison unit 151, a second variation feature comparison unit 152, a third variation feature comparison unit 153, an SNR_SP calculation unit 154, a TILT_SP calculation unit 155, a ZC_SP calculation unit 156, and a speech presence possibility (SPP) calculation unit 157.

The LP-LTP gain generation unit 121 generates an LP-LTP gain of the current frame by short-term analysis with respect to each frame of the input audio signal as a short-term feature.

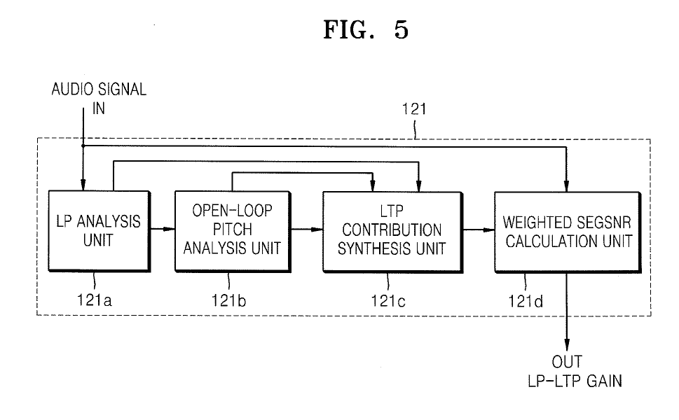

FIG. 5 is a detailed block diagram of the LP-LTP gain generation unit 121 of FIG. 4. Referring to FIGS. 4 and 5, the LP-LTP gain generation unit 121 includes an LP analysis unit 121a , an open-loop pitch analysis unit 121b , an LTP contribution synthesis unit 121c , and a weighted SegSNR calculation unit 121d.

The LP analysis unit 121a calculates a coefficient ^{PrdErr}, ^{r[0]} by performing linear analysis with respect to an audio signal corresponding to the current frame and calculates an LPC gain using the calculated value as follows:

LPC gain=−10.*log 10((PrdErr/(r[0]+0.0000001)) (1)

where ^{PrdErr} is a prediction error according to Levinson-Durbin that is a process of obtaining an LP filter coefficient and ^{r[0]} is the first reflection coefficient.

The LP analysis unit 121a calculates a linear prediction coefficient (LPC) using autocorrelation with respect to the current frame. At this time, a short-term analysis filter is specified by the LPC and a signal passing through the specified filter is transmitted to the open-loop pitch analysis unit 121b.

The open-loop pitch analysis unit 121b calculates a pitch correlation by performing long-term analysis with respect to an audio signal that is filtered by the short-term analysis filter. The open-pitch loop analysis unit 121b calculates an open-loop pitch lag for the maximum cross correlation between an audio signal corresponding to a previous frame stored in the buffer 160 and an audio signal corresponding to the current frame and specifies a long-term analysis filter using the calculated lag. The open-loop pitch analysis unit 121b obtains a pitch using correlation between a previous audio signal and the current audio signal, which is obtained by the LP analysis unit 121a , and divides the correlation by the pitch, thereby calculating a normalized pitch correlation. The normalized pitch correlation rₓ can be calculated as follows:

$${r}_{x} = \frac{{\sum }_{i} {x}_{i} {x}_{i - T}}{\sqrt{{\sum }_{i} {x}_{i} {x}_{i} {\sum }_{i} {x}_{i - T} {x}_{i - T}}} , \qquad ( 2 )$$

where T is an estimation value of an open-loop pitch period and xᵢ is a weighted input signal.

The LP-LTP synthesis unit 121c receives zero excitation as an input and performs LP-LTP synthesis.

The weighted SegSNR calculation unit 121d calculates an LP-LTP gain of a reconstructed signal that is output from the LP-LTP synthesis unit 121c. The LP-LTP gain, which is a short-term feature of the current frame, is transmitted to the LP_LTP gain moving average calculation unit 141.

The LP_LTP gain moving average calculation unit 141 calculates an average of LP-LTP gains of a predetermined number of previous frames preceding the current frame, which are stored in the short-term feature buffer 161.

The first variation feature comparison unit 151 receives a difference SNR_VAR between the moving average calculated by the LP_LTP gain moving average calculation unit 141 and the LP-LTP gain of the current frame and compares the received difference with a predetermined threshold SNR_THR.

The SNR_SP calculation unit 154 calculates a long-term feature SNR_SP by an ‘if’ conditional statement according to the comparison result obtained by the first variation feature comparison unit 151, as follows:

if (SNR_{—}VAR>SNR_{—}THR) SNR_{—}SP=a₁*SNR_{—}SP+(1−a)*SNR_{—}VAR (3),

else

SNR_SP=D₁

where an initial value of SNR_SP is 0, a₁ is a real number between 0 and 1 and is a weight for SNR_SP and SNR_VAR, and D₁ is β₁×(SNR_THR/LT−LTP gain) in which β₁ is a constant indicating the degree of reduction.

In Equation 3, a₁ is a constant that suppresses a mode change between the speech mode and the music mode, caused by noise, and the larger a₁ allows smoother reconstruction of an audio signal. According to the ‘if’ conditional statement expressed by Equation 3, the long-term feature SNR_SP increases when SNR_VAR is greater than the threshold SNR_THR and the long-term feature SNR_SP is reduced from a long-term feature SNR_SP of a previous frame by a predetermined value when the variation feature SNR_VAR is less than the threshold SNR_THR.

The SNR_SP calculation unit 154 calculates the long-term feature SNR_SP by executing the ‘if’ conditional statement expressed by Equation 3. The variation feature SNR_VAR is also a kind of long-term feature, but is transformed into the long-term feature SNR_SP having a distribution illustrated in FIG. 6D.

FIGS. 6A through 6D are reference diagrams illustrating distribution features of SNR_VAR, SNR_THR, and SNR_SP according to the current exemplary embodiment.

FIG. 6A is a screen shot illustrating a variation feature SNR_VAR of an LP-LTP gain according to a music signal and a speech signal. It can be seen from FIG. 6A that the variation feature SNR_VAR generated by the LP-LTP gain generation unit 121 has different distributions according to whether an input signal is a speech signal or a music signal.

FIG. 6B is a reference diagram illustrating the statistical distribution feature of a frequency percent according to the variation feature SNR_VAR of the LP-LTP gain. In FIG. 6B, a vertical axis indicates a frequency percent, i.e., (frequency of SNR_VAR/total frequency) x 100%. An uttered speech signal is generally composed of voiced sound, unvoiced sound, and silence. The voiced sound has a large LP-LTP gain and the unvoiced sound or silence has a small LP-LTP gain. Thus, most speech signals having a switch between voiced sound and unvoiced sound have a large variation feature SNR_VAR within a predetermined interval. However, music signals are continuous or have a small LP-LTP gain change and thus have a smaller variation feature SNR_VAR than the speech signals.

FIG. 6C is a reference diagram illustrating the statistical distribution feature of a cumulative frequency percent according to the variation feature SNR_VAR of an LP-LTP gain. Since music signals are mostly distributed in an area having small variation feature SNR_VAR, the possibility of the presence of the music signal is very low when the variation feature SNR-VAR is greater than a predetermined threshold as can be seen in a cumulative curve. A speech signal has a gentler cumulative curve than a music signal. In this case, a threshold THR may be defined as P(music|S)-P(speech|S), and the variation feature SNR_VAR corresponding to a maximum threshold THR may be defined as a long-term feature threshold (SNR-THR). Here, P(music|S) is the probability that the current audio signal is a music signal under a condition S and P(speech|S) is a probability that the current audio signal is a speech signal under the condition S. In the present embodiment, the long-term feature threshold SNR_THR is employed as a criterion for executing a conditional statement for obtaining the long-term feature SNR_SP, thereby improving the accuracy of distinguishment between a speech signal and a music signal.

FIG. 6D is a reference diagram illustrating a long-term feature SNR_SP according to an LP-LTP gain. The SNR_SP calculation unit 154 generates a new long-term feature SNR_SP for the variation feature SNR_VAR having a distribution illustrated in FIG. 6A by executing the conditional statement. It can also be seen from FIG. 6D that SNR_SP values for a speech signal and a music signal, which are obtained by executing the conditional statement according to the threshold SNR_THR, are definitely distinguished from each other.

Referring back to FIG. 4, the spectrum tilt generation unit 122 generates a spectrum tilt of the current frame using short-term analysis for each frame of an input audio signal as a short-term feature. The spectrum tilt is a ratio of energy according to a low-band spectrum and energy according to a high-band spectrum and is calculated as follows:

eₜᵢₗₜ=E₁/Eₕ (4),

where Eₕ is an average energy in a high band and E₁ is an average energy in a low band. The spectrum tilt average calculation unit 142 calculates an average of spectrum tilts of a predetermined number of frames preceding the current frame, which are stored in the short-term feature buffer 161, or calculates an average of spectrum tilts including the spectrum tilt of the current frame generated by the spectrum tilt generation unit 122.

The second variation feature comparison unit 152 receives a difference Tilt_VAR between the average generated by the spectrum tilt average calculation unit 142 and the spectrum tilt of the current frame generated by the spectrum tilt generation unit 122 and compares the received difference with a predetermined threshold TILT_THR.

The TILT_SP calculation unit 155 calculates a tilt speech possibility TILT_SP that is a long-term feature by executing an ‘if’ conditional statement expressed by Equation 5 according to the comparison result obtained by the spectrum tilt variation feature comparison unit 152, as follows:

if (TILT_{—}VAR>TILT_{—}THR) TILT_{—}SP=a₂*TILT_{—}SP+(1−a₂)*TILT_{—}VAR (5),

else

TILT_SP=D₂

where an initial value of TILT_SP is 0, a₂ is a real number between 0 and 1 and is a weight for TILT_SP and TILT_VAR, and D₂ is β₂×(TILT_THR/SPECTRUM TILT) in which β₂ is a constant indicating the degree of reduction. A detailed description that is common to TILT_SP and SNR_SP will not be given.

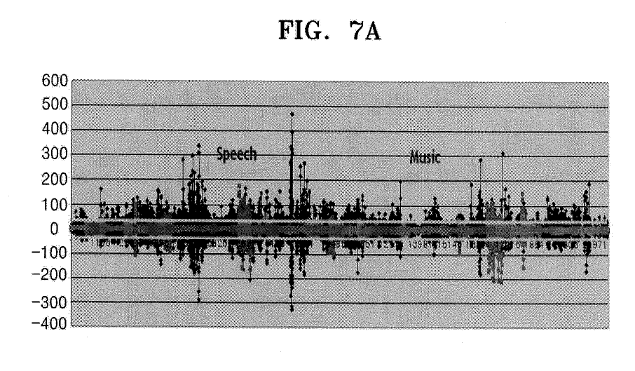

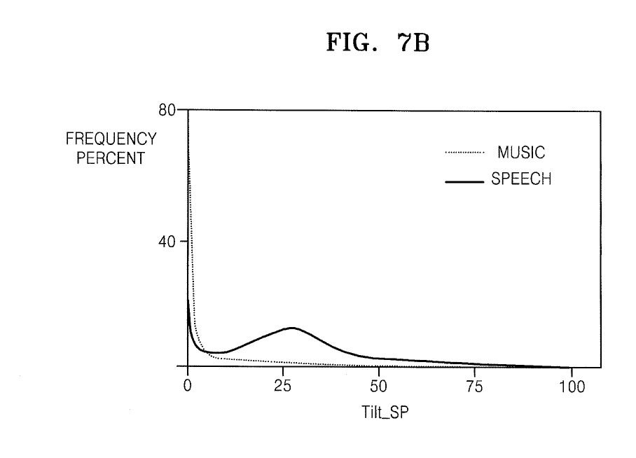

FIG. 7A is a screen shot illustrating a variation feature TILT_VAR of a spectrum tilt gain according to a music signal and a speech signal. The variation feature TILT_VAR generated by the spectrum tilt generation unit 122 differs according to whether an input signal is a speech signal or a music signal.

FIG. 7B is a reference diagram illustrating a long-term feature TILT_SP of a spectrum tilt. The TILT_SP calculation unit 155 generates a new long-term feature TILT_SP by executing the conditional statement with respect to a variation feature TILT_VAR having a distribution illustrated in FIG. 7B. It can also be seen from FIG. 7B that TILT_SP values for a speech signal and a music signal, which are obtained by executing the conditional statement according to the threshold TILT_THR, are definitely distinguished from each other.

Referring back to FIG. 4, the ZCR generation unit 123 generates a zero crossing rate of the current frame by performing short-term analysis for each frame of the input audio signal as a short-term feature. The zero crossing rate means the frequency of occurrence of a signal change in input samples with respect to the current frame and is calculated according to a conditional statement using Equation 6 as follows:

if(S(n)·S(n−1)<0) ZCR=ZCR+1 (6),

where S(n) is a variable for determining whether an audio signal corresponding to the current frame n is a positive value or a negative value and an initial value of ZCR is 0.

The ZCR average calculation unit 143 calculates an average of zero crossing rates of a predetermined number of previous frames preceding the current frame, which are stored in the short-term feature buffer 161, or calculates an average of zero crossing rates including the zero crossing rate of the current frame, which is generated by the ZCR generation unit 123.

The third variation feature comparison unit 153 receives a difference ZC_VAR between the average generated by the ZCR average calculation unit 143 and the zero crossing rate of the current frame generated by the ZCR generation unit 123 and compares the received difference with a predetermined threshold ZC_THR.

The ZC_SP calculation unit 156 calculates ZC_SP that is a long-term feature by executing an ‘if’ conditional statement expressed by Equation 7 according to the comparison result obtained by the zero crossing rate variation feature comparison unit 153, as follows:

if (ZC_{—}VAR>ZC_{—}THR) ZC_{—}SP=a₃*ZC_{—}SP+(1−a₃)*ZC_{—}VAR (7),

else

ZC_SP=D₃

where an initial value of ZC_SP is 0, a₃ is a real number between 0 and 1 and is a weight for ZC_SP and ZC_VAR, D₃ is β₃×(ZC_THR/zero-crossing rate) in which β₃ is a constant indicating the degree of reduction, and zero-crossing rate is a zero crossing rate of the current frame. A detailed description that is common to ZC_SP and SNR_SP will not be given.

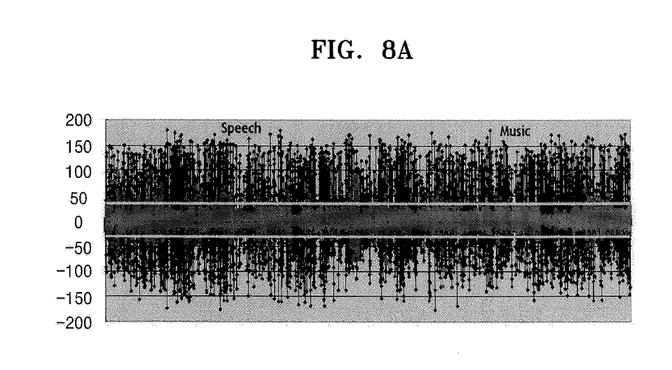

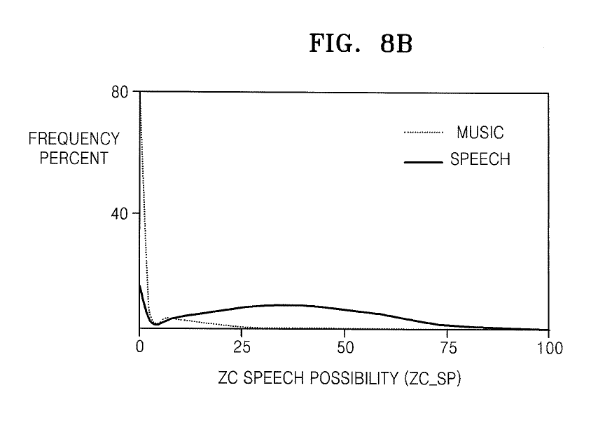

FIG. 8A is a screen shot illustrating a variation feature ZC_VAR of a zero crossing rate according to a music signal and a speech signal. ZC_VAR generated by the ZCR generation unit 123 differs according to whether an input signal is a speech signal or a music signal.

FIG. 8B is a reference diagram illustrating a long-term feature ZC_SP of a zero crossing rate. The ZC_SP calculation unit 155 generates a new long-term feature value ZC_SP by executing the conditional statement with respect to the variation feature ZC_VAR having a distribution as illustrated in FIG. 8B. It can also be seen from FIG. 8B that the long-term feature ZC_SP values for a speech signal and a music signal, which are obtained by executing the conditional statement according to the threshold ZC_THR, are definitely distinguished from each other.

The SPP generation unit 157 generates a speech presence possibility (SSP) using a long-term feature calculated by the SNR_SP calculation unit 154, the TILT_SP calculation unit 155, and the ZC_SP calculation unit 156, as follows:

SPP=SNR_{—}W·SNR_{—}SP+TILT_{—}W·TILT_{—}SP+ZC_{—}W·ZC_{—}SP (8),

where SNR_W is a weight for SNR_SP, TILT_W is a weight for TILT_SP, and ZC_W is a weight for ZC_SP.

Referring to FIGS. 6C, 7B, and 8B, ^{SNR}^{_{—}}^{W} is calculated by multiplying P(music|S)-P(speech|S)=0.46(46%) according to SNR_THR by a predetermined normalization factor. Here, although there is no special restriction on the normalization factor, SNR_SP(=7.5) for a 90% SNR_SP cumulative probability of a speech signal may be set to the normalization factor. Similarly, ^{TILT}^{_{—}}^{W} is calculated using P(music|T)-P(speech|T)=0.35(35%) according to TILT_THR and a normalization factor for ^{TILT}^{_{—}}^{SP}. The normalization factor for ^{TILT}^{_{—}}^{SP} is TILT_SP(=45) for a 90% TILT_SP cumulative probability of a speech signal. ^{ZC}^{_{—}}^{W} can also be calculated using P(music|Z)-P(speech|Z)=0.32(32%) according to ZC_THR and a normalization factor(=75) for ^{ZC}^{_{—}}^{SP}.

FIG. 9A is a reference diagram illustrating the distribution feature of an SPP generated by the SPP generation unit 157. The short-term features generated by the LP-LTP gain generation unit 121, the spectrum tilt generation unit 122, and the ZCR generation unit 123 are transformed into a new long-term feature SPP by the above-described process and a speech signal and a music signal can be more definitely distinguished from each other based on the long-term feature SPP.

FIG. 9B is a reference diagram illustrating a cumulative long-term feature according to the long-term feature SPP of FIG. 9A. A long-term feature threshold SpThr may be set to an SPP for a 99% cumulative distribution of a music signal. When the SPP of the current frame is greater than the threshold SpThr, a speech mode may be determined as the encoding mode for the current frame. However, when the SPP of the current frame is less than the threshold SpThr, a mode determination threshold for determining a short-term feature is adjusted based on the mode of the previous frame and the adjusted mode determination threshold is compared with the short-term feature, thereby determining the encoding mode for the current frame.

Although the short-term feature generation unit 120 is described to include the LP-LTP gain generation unit 121, the spectrum tilt generation unit 122, and the zero crossing rate (ZCR) generation unit 123, it is possible that the short-term feature generation unit 120 includes one or a combination of the LP-LTP gain generation unit 121, the spectrum tilt generation unit 122, and the zero crossing rate (ZCR) generation unit 123.

Also, the long-term feature generation unit 130 may include one or a combination of a first processing unit including the LP-LTP gain moving average calculation unit 141, the first variation feature comparison unit 151, the SNR_SP calculation unit 154, a second processing unit including the spectrum tilt moving average calculation unit 142, the second variation feature comparison unit 152, and the TILT_SP calculation unit 155, and a third processing unit including the zero crossing rate moving average calculation unit 143, the third variation feature comparison unit 153, and the ZC_SP calculation unit 156, according to the one or combination of the LP-LTP gain generation unit 121, the spectrum tilt generation unit 122, and the zero crossing rate (ZCR) generation unit 123 of the short-term feature generation unit 120.

In this case, the SPP calculation unit 157 may calculate the speech presence possibility (SPP) from one or a combination of the long-term features SNR_SP, TILT_SP, and ZC_SP.

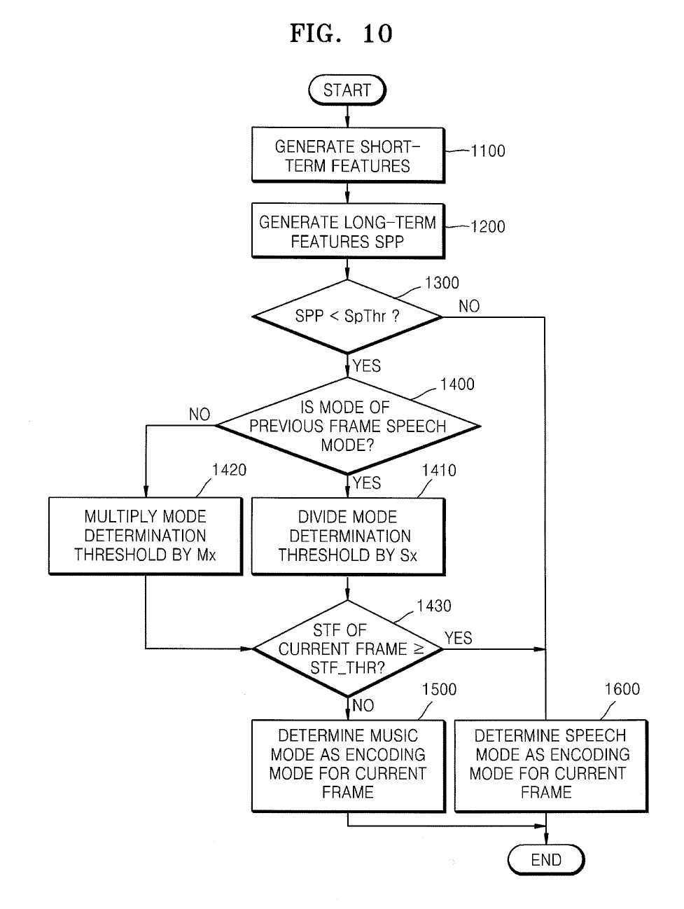

FIG. 10 is a flowchart illustrating a method of determining an encoding mode to encode an audio signal according to an exemplary embodiment of the present general inventive concept.

Referring to FIGS. 3, 4, and 10, in operation 1100, the short-term feature generation unit 120 divides an input audio signal into frames and calculates an LP-LTP gain, a spectrum tilt, and a zero crossing rate by performing short-term analysis with respect to each of the frames. Although there is no special restriction on the type of short-term feature, a hit rate of 90% or higher can be achieved when the encoding mode for the audio signal is determined for each frame using three types of short-term features. The calculation of the short-term features has already been described above and thus will be omitted here.

In operation 1200, the long-term feature generation unit 130 calculates long-term features SNR_SP, TILT_SP, and ZC_SP by performing long-term analysis with respect to the short-term features generated by the short-term feature generation unit 120 and applies weights to the long-term features, thereby calculating an SPP.

In operation 1100 and operation 1200, short-term features and long-term features of the current frame are calculated. However, it is also necessary to conduct training with respect to speech data and music data, i.e., calculation of short-term features and long-term features by performing operation 1100 and operation 1200, in order to determine the encoding mode for the audio signal. Due to the training, data establishment for the distributions of the short-term features and the long-term features can be achieved and the encoding mode for each frame of the audio signal can be determined as will be described below.

In operation 1300, the long-term feature comparison unit 170 compares SPP of the current frame calculated in operation 1200 with a preset long-term feature threshold SpThr. When SPP is greater than SpThr, the speech mode is determined as the encoding mode for the current frame. When SPP is less than SpThr, a mode determination threshold is adjusted and the adjusted mode determination threshold is compared with a short-term feature, thereby determining the encoding mode for the current frame.

In operation 1400, the mode determination threshold adjustment unit 180 receives mode information about the encoding mode of the previous frame from the long-term feature comparison unit 170 and determines whether the encoding mode of the previous frame is the speech mode or the music mode according to the received mode information.

In operation 1410, the mode determination threshold adjustment unit 180 outputs a value obtained by dividing a mode determination threshold STF_THR for determining a short-term feature of the current frame by a value Sx when the encoding mode of the previous frame is the speech mode. Sx is a value having an attribute of a cumulative probability of a speech signal and is intended to increase or reduce the mode determination threshold. Referring to FIG.9A, SPP for an Sx of 1 is selected and a cumulative probability with respect to each SPP is divided by a cumulative probability with respect to SpSx, thereby calculating normalized Sx. When SPP of the current frame is between SpSx and SpThr, the mode determination threshold STF_THR is reduced in operation 1410 and the possibility that the speech mode is determined as the encoding mode for the current frame is increased.

In operation 1420, the mode determination threshold adjustment unit 180 outputs a product of the mode determination threshold STF_THR for determining the short-term feature of the current frame and a value Mx when the encoding mode of the previous frame is the music mode. Mx is a value having an attribute of a cumulative probability of a music signal and is intended to increase or reduce the mode determination threshold. As illustrated in FIG. 9B, a music presence possibility (MPP) for an Mx of 1 may be set as MpMx and a probability with respect to each MPP is divided by a probability with respect to MpMx, thereby calculating normalized Mx. When Mx is greater than MpMx, the mode determination threshold STF_THR is increased and the possibility that the music mode is determined as the encoding mode for the current frame is also increased.

In operation 1430, the mode determination threshold adjustment unit 180 compares a short-term feature of the current frame with the mode determination threshold that is adaptively adjusted in operation 1410 or operation 1420 and outputs the comparison result.

When the short-term feature of the current frame is less than the mode determination threshold in operation 1430, the encoding mode determination unit 190 determines the music mode as the encoding mode for the current frame and outputs the determination result as mode information in operation 1500.

When the short-term feature of the current frame is greater than the mode determination threshold in operation 1430, the encoding mode determination unit 190 determines the speech mode as the encoding mode for the current frame and outputs the determination result as mode information in operation 1600.

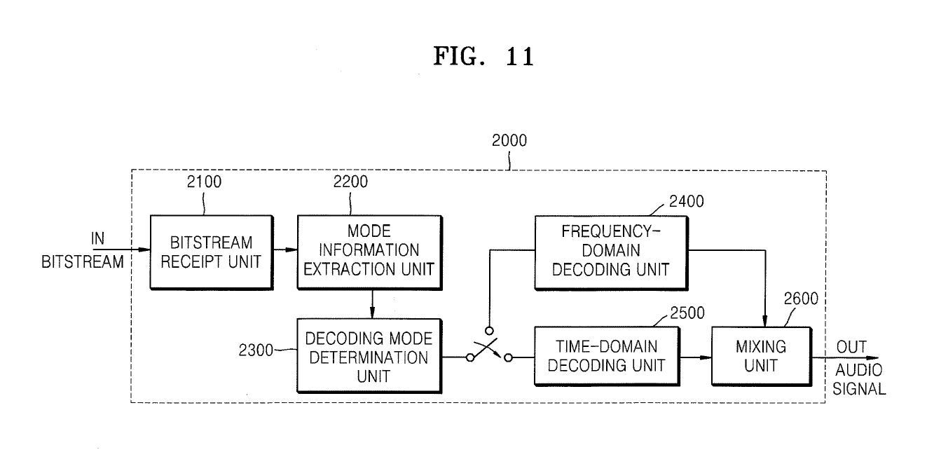

FIG. 11 is a block diagram of a decoding apparatus 2000 to decode an audio signal according to an exemplary embodiment of the present general inventive concept.

Referring to FIG. 11, a bitstream receipt unit 2100 receives a bitstream including mode information for each frame of an audio signal. A mode information extraction unit 2200 extracts the mode information from the received bitstream. A decoding mode determination unit 2300 determines a decoding mode for the audio signal according to the extracted mode information and transmits the bitstream to a frequency-domain decoding unit 2400 or a time-domain decoding unit 2500.

The frequency-domain decoding unit 2400 decodes the received bitstream in the frequency domain and the time-domain decoding unit 2500 decodes the received bitstream in the time domain. A mixing unit 2600 mixes decoded signals in order to reconstruct an audio signal.

The present general inventive concept can also be embodied as computer-readable code on a computer-readable medium. The computer-readable medium can include a computer-readable recording medium and a computer-readable transmission medium. The computer-readable recording medium is any data storage device that can store data which can be thereafter read by a computer system.

Examples of the computer-readable recording medium include read-only memory (ROM), random-access memory (RAM), CD-ROMs, magnetic tapes, floppy disks, optical data storage devices, and so on. The computer-readable recording medium can also be distributed over network coupled computer systems so that the computer-readable code is stored and executed in a distributed fashion. The computer-readable transmission medium can transmit carrier waves and signals (e.g., wired or wireless data transmission through the Internet). Also, functional programs, code, and code segments for implementing the present invention can be easily construed by programmers skilled in the art.

As described above, according to the present general inventive concept, an encoding mode for the current frame is determined by adaptively adjusting a mode determination threshold for the current frame according to a long-term feature of the audio signal, thereby improving a hit rate of encoding mode determination and signal classification, suppressing frequent mode switching per frame, improving noise tolerance, and providing smooth reconstruction of the audio signal.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to determine an encoding mode to encode an audio signal, comprising:
a determination unit to determine an encoding mode of a first frame of an audio signal according to a short-term feature of the first frame and a long-term feature between the first frame and one second frame or more second frames so that the first frame of the audio signal is encoded according to the encoding mode.

2. The apparatus of claim 1, further comprising:
a time-domain coding unit to encode the audio signal according to the encoding mode and a time-domain; and
a frequency-domain coding unit to encode the audio signal according to the encoding mode and a frequency-domain.

3. The apparatus of claim 1, further comprising:
a speech coding unit to encode the audio signal as a speech signal according to the encoding mode; and
a music coding unit to encode the audio signal as a music signal according to the encoding mode.

4. The apparatus of claim 1, further comprising:
a speech coding unit to receive the audio signal and the encoding mode from the determining unit to encode the audio signal when the encoding mode is a speech signal encoding mode; and
a music coding unit to receive the audio signal and the encoding mode from the determining unit to encode the audio signal when the encoding mode is a music signal encoding mode.

5. The apparatus of claim 1, further comprising:
a coding unit to encode the audio signal according to the encoding mode; and
a bitstream generation unit to generate a bitstream according to the encoded audio signal and information on the encoding mode.

6. The apparatus of claim 1, wherein the determining unit comprises:
a short term feature generation unit to generate the short-term feature from the first frame of the audio signal; and
a long-term feature generation unit to generate the long-term feature from the first frame and the second frame or the second frames.

7. The apparatus of claim 6, wherein the determining unit further comprises:
a mode determination threshold adjustment unit to adjust a mode determination threshold according to the short term feature and the long-term feature; and
an encoding determination unit to determine the encoding mode according to the adjusted mode determination threshold and the short-term feature.

8. The apparatus of claim 7, wherein the mode determination threshold adjustment unit adjusts the mode determination threshold according to the short term feature, the long-term feature, and a second encoding mode of the second frame or the second frames.

9. The apparatus of claim 7, wherein the encoding determination unit determines the encoding mode according to the adjusted mode determination threshold, the short-term feature, and a second encoding mode of the second frame or the second frames.

10. The apparatus of claim 6, wherein the long-term feature generation unit comprises:
a first long-term feature generation unit to generate a first long-term feature according to the short-term feature of the first frame and a second short-term feature of the second feature; and
a second long-term feature generation unit to generate a second long-term feature as the long-term feature according to the first long-term feature and a variation feature of at least one of the first frame and the second frame or the second frames.

11. The apparatus of claim 10, wherein the determination unit further comprises:
a mode determination threshold adjustment unit to adjust a mode determination threshold according to the short term feature and the second long-term feature; and
an encoding determination unit to determine the encoding mode according to the adjusted mode determination threshold and the short-term feature.

12. The apparatus of claim 1, wherein the determination unit determines the encoding mode of the first frame of the audio signal according to the short-term feature of the first frame, the long-term feature between the first frame and the second frame or the second frames, and a second encoding mode of the second frame or the second frames.

13. The apparatus of claim 1, wherein the determination unit comprises:
an LP-LTP gain generation unit to generate an LP-LTP gain as the short-term feature of the first frame; and
a long-term feature generation unit to generate the long-term feature according to the LP-LTP gain of the first frame and a second LP-LTP gain of the second frame or the second frames.

14. The apparatus of claim 1, wherein the determination unit comprises:
a spectrum tilt generation unit to generate a spectrum tilt as the short-term feature of the first frame; and
a long-term feature generation unit to generate the long-term feature according to the spectrum tilt of the first frame and a second spectrum tilt of the second frame or the second frames.

15. The apparatus of claim 1, wherein the determination unit comprises:
a zero crossing rate generation unit to generate a zero crossing rate as the short-term feature of the first frame; and
a long-term feature generation unit to generate the long-term feature according to the zero crossing rate of the first frame and a second zero crossing rate of the second frame or the second frames.

16. The apparatus of claim 1, wherein the determination unit comprises:
a short-term feature generation unit having one or a combination of an LP-LTP gain generation unit to generate an LP-LTP gain as the short-term feature of the first frame, a spectrum tilt generation unit to generate a spectrum tilt as the short-term feature of the first frame, and a zero crossing rate generation unit to generate a zero crossing rate as the short-term feature of the first frame; and
a long-term feature generation unit to generate the long-term feature according to the short-term feature of the first frame and a second short-term feature of the second frame or the second frames.

17. The apparatus of claim 1, wherein the determination unit comprises a memory to store the short-term and long-term features of the first and second frames.

18. The apparatus of claim 1, wherein:
the first frame is a current frame;
the second frame comprises a plurality of previous frames; and
the long-term feature is determined according to the short-term feature of the first frame and second short-term features of the plurality of the previous frames.

19. The apparatus of claim 1, wherein:
the first frame is a current frame;
the second frame comprises a previous frame; and
the long-term feature is determined according to a variation feature between the current frame and the previous frame.

20. The apparatus of claim 1, wherein:
the first frame is a current frame;
the second frame comprises a previous frame; and
the long-term feature is determined according to a variation feature of a second encoding mode of the previous frame.

21. An apparatus to encode an audio signal, comprising:
a determination unit to determine an encoding mode of a first frame of an audio signal according to a short-term feature of the first frame, a long-term feature between the first frame and one second frame or second frames, and a second encoding mode of the second frame or the second frames, so that the first frame of the audio signal is encoded according to the encoding mode.

22. An apparatus to encode an audio signal, comprising:
a determining unit to determine one of a speech mode and a music mode as an encoding mode to encode an audio signal according to a unique characteristic of a frame the audio signal and a relative characteristic of adjacent frames of the audio signal.

23. An apparatus to decode a signal of a bitstream, comprising:
a determining unit to determine an encoding mode from a bitstream having en encoded signal and information on the encoding mode of the encoded signal, so that the encoded signal of the bitstream is decoded according to the determined encoding mode.

24. An apparatus to encode and/or decode an audio signal, comprising:
a first determining unit to determine an encoding mode of a first frame of an audio signal according to a short-term feature of the first frame and a long-term feature between the frame and one second frame or second frames so that the first frame of the audio signal is encoded according to the encoding mode; and
a second determining unit to determine the encoding mode from a bitstream having the encoded signal and information on the encoding mode, so that the encoded signal of the bitstream is decoded according to the determined encoding mode.
